(19) United States
(12) Patent Application Publication
(10) Pub. No.: US 2014/0182810 A1
(43) Pub. Date: Jul. 3, 2014

(54) Environmental Control Method and Apparatus for a Vehicle

(71) Applicant: Boice Manufacturing, Inc. d/b/a Warner Bodies, Inc, Noblesville, IN (US)

(72) Inventor: Richard J. Manasek, Greenwood, IN (US)

(21) Appl. No.: 14/141,411

(22) Filed: Dec. 26, 2013

Related U.S. Application Data
(60) Provisional application No. 61/746,301, filed on Dec. 27, 2012.

(51) Int. Cl. B60H 1/18; F01N 5/02

(52) U.S. Cl. CPC B60H 1/18; F01N 5/02
USPC 165/41; 60/320

(57) ABSTRACT

A heat transfer apparatus and system for transferring heat for use onboard a vehicle includes a conductor arranged to conduct fluid transferring heat from a vehicle engine to a heat exchanger to heat a second fluid to heat and/or dry utility compartments of the vehicle. The heat transfer system includes a tube arranged to conduct fluid so that heat is transferred from the exhaust gas to the fluid.

### CROSS REFERENCE TO RELATED APPLICATIONS

This application claims priority to and the benefit of U.S. Provisional Patent Application No. 61/746,301, filed 27 Dec. 2012, the disclosure of which is now expressly incorporated herein by reference.

### TECHNICAL FIELD

The present application generally relates to systems for transferring heat for use in a vehicle, and in particular to onboard vehicle heat sources. More particularly, the present application relates to heat exchangers for transferring heat from vehicle heat sources to vehicle utility areas.

### BACKGROUND AND SUMMARY OF THE INVENTION

Vehicles illustratively have environmental control systems to manage the heating or cooling of the passenger cabin of the vehicle, or to otherwise manage the heat developed by the engine. Typically, environment control is provided for the passenger cabin by transferring heat to and from the engine to the vehicle heating or cooling system. Illustratively, excess heat may be lost to the ambient atmosphere rather than being recycled. In addition, in the case of a utility vehicle or utility body, a separate environmental system generally must be provided.

Illustratively, a heat exchanger facilitates heat transfer from one medium to another. The media may be separated by a solid wall, so that they never mix, or they may be in direct contact with one another so that they mix. A radiator is a type of heat exchanger that transfers thermal energy from one medium to another for the purpose of cooling and heating. The radiator is a source of heat to its environment, although this may be either for heating this environment, or for cooling the fluid or coolant supplied to it, as for engine cooling. Radiators generally transfer heat via convection. In the case of an engine, for example an internal combustion engine used in a vehicle, a circulating fluid, for example an engine coolant, is passed through the engine to absorb the heat from the combustion process. The now heated coolant then flows through the inlet tank to the radiator and distributed across the radiator core, for example its coils. As the coolant circulates through the radiator tubes or coils on its way to the opposite tank, a second fluid, for example air, flows past the coils. Illustratively a pump is used to circulate the coolant. The coolant transfers its heat to the tubes which, in turn, transfer the heat to the fins that are lodged between each row of radiator tubes. The fins then release the heat to the ambient air flowing past the coils. One or more fans or blowers, and/or ambient ram air may be used to force or blow air through the radiator. The air recovers the heat from the engine coolant thereby lowering the temperature of the coolant and increasing the temperature of the incoming air. The now cold coolant is fed back to the engine, and the cycle repeats. The heated air may be diverted to heat the vehicle's passenger cabin, or it may be dissipated to the atmosphere.

The present invention may comprise one or more of the following features and combinations thereof.

The illustrative embodiments disclosed herein illustratively recover heat from vehicle heat transfer systems. In addition, the illustrative embodiments use this recovered heat to provide a heated and/or dry environment to areas outside of the passenger cabin, including for example and without limitation a utility body's enclosed compartments, side packs, cabinets in side packs, tool boxes, utility box, and any other covered portion of the utility body. Illustratively, such covered portions will include top wall(s), bottom wall(s), and side walls of any number, shape and configuration. For example, an illustrative compartment may be a square, a rectangle, a pyramid, a cone, or the like so long as it can define an enclosed space. The compartment, while defining an enclosed space, need not be continuous or solid. For example, one or more of the walls may define openings or apertures therethrough including for example doors or drawers that open, and/or entry/exit openings for circulating heating fluid into the compartment. In addition, the illustrative embodiments keep items such as for example and without limitation tools, instruments and the like located in the utility box or other compartment or area outside the passenger cabin warm and dry during cold weather and dry and dampness free during warm seasonal time periods.

Illustratively, the heat may be recovered from the vehicle radiator cooling system, from the vehicle exhaust gas, and/or from a combination of the radiator cooling system and the vehicle exhaust system. The recovered heat illustratively may then be used to heat and/or keep dry desired regions of the vehicle, for example and without limitation areas, regions or compartments outside of the vehicle passenger cabin.

Illustratively, the disclosed embodiments capture, recycle and transfer heat dissipated from the vehicle or chassis radiator system and/or the vehicle or chassis exhaust system for the purpose of heating and/or drying any enclosed areas or compartments in utility bodies.

Illustratively, the disclosed embodiments create no additional demands on vehicle fuel consumption.

Illustratively, the disclosed embodiments simply require heat exchangers and tubing to transfer heat from the heat sources to the desired compartments.

A heat transfer system in accordance with the present disclosure illustratively may be carried onboard a motor vehicle to extract heat from a heat source and to transfer the extracted heat to a heat carrier. The system may comprise a carrier heat exchanger and/or a utility heat exchanger and associated transfer piping or conduits. In one illustrative embodiment, the heat source is, for example, exhaust gas discharged from the engine of the vehicle and the heat carrier is, for example, the exhaust gas. In another illustrative embodiment, the heat source is, for example, exhaust gas discharged from the engine of the vehicle and the heat carrier is, for example, another fluid such as for example ambient air. In another illustrative embodiment, the heat source is, for example, exhaust gas discharged from the engine of the vehicle and the heat carrier is, for example engine coolant fluid. In another illustrative embodiment, the heat source is, for example, exhaust gas discharged from the engine of the vehicle and the heat carrier is, for example a coolant fluid from a source independent of the engine. In another illustrative embodiment, the heat source is, for example, engine coolant fluid discharged from the engine of the vehicle and the heat carrier is, for example the engine coolant fluid. Illustratively, the heat carrier transfers or carries the heat extracted from the heat source to a utility heating and drying system, for example a utility heat exchanger, to heat or keep dry a utility compartment outside of the passenger cabin and/or any items or articles located therein.

Illustratively, the heat transfer system includes heat source conductor means for conducting a fluid such as radiator cooling fluid or exhaust gas discharged from an engine along a path for transmission to the heat transfer system. The heat source or exhaust conductor means may comprise heat source conduit(s), tube(s) or piping.

The heat transfer system may further include heat carrier fluid conductor means for conducting a heat carrier fluid through the outer exhaust gas passageway, or the carrier heat exchanger to heat the heat carrier fluid using heat from the exhaust gas passing through the annular outer exhaust gas passageway and providing the heated fluid for use in a utility heating and/or drying system for use in utility areas of the vehicle.

The heat carrier fluid conductor means illustratively may comprise a coil extending through the outer exhaust gas passageway. The coil surrounds the intermediate and inner tubes.

Illustratively, the disclosed embodiments recover heat in the illustrative manners and recycle the heat to desired area(s) of a utility body for the purpose of keeping desired utility space or spaces at a higher temperature than ambient for the purpose of heating and or drying the enclosed spaces.

Illustratively, a fluid, for example a heat source fluid or a heat carrier fluid, is directed or cycled through a utility heat exchange system for further direction to desired utility body compartments requiring heating. The heat source fluid may flow through form a heat source all the way through to the utility heat exchange system such that it is also serves as the heat carrier fluid without the need for further heat transfer or conditioning. The heat source fluid may comprise a gas, such as for example exhaust gas from a vehicle engine, or a liquid such as for example water or antifreeze fluid also from the vehicle engine. The heat source fluid illustratively flows to one or more enclosed chamber(s) through a series of transfer pipe or conduit(s) and into a utility heat exchanger that illustratively is in communication with a blower fan to circulate utility heat fluid, for example air, over the heat exchanger pipe/coils/plates that have been heated by the heat source fluid and/or the heat carrier fluid. The heat is transferred from the utility heat exchanger to the utility heat fluid, for example air, which is forced or blown into the specific compartment, heating it to the desired temperature. The system illustratively could include temperature monitoring in the compartment that allows the temperature of the compartment to be controlled by a series of shut-off valves, or by a bypass mode, that control heat fluid flow to the compartment based on the temperature of the compartment. The fans could be a suction fan on the exit end of the heated compartment or a forced air fan on the entry end of the heated compartment. Illustratively, heated fluid could be designed to flow through a series of compartments by applying gas flow openings to assure that proper ventilation occurs throughout the compartment and does not short circuit from one compartment through the other. The general arrangement will be to have an entry opening on the upper end of a side wall or a horizontal wall and have the exit openings on the opposite walls located to assure that the heat fluid traverses across and through the entire compartment.

In another illustrative embodiment, the heat carrier fluid may comprise a water or antifreeze mixture, which flows or is directed through a carrier heat exchanger which illustratively may either cover or replace the vehicle's exhaust pipe or heat source conduit to transfer heat from the heat source fluid, for example the vehicle's exhaust gas, to the heat carrier fluid. This heat carrier fluid illustratively may be fed into a fluid splitter and control box as further described herein. Illustratively, the carrier heat exchanger could either replace the entire exhaust pipe as a single unit or it could be for example a bolt on device that attaches to the exterior of the existing exhaust pipe. The heat carrier fluid is then directed through the utility heat exchanger as has been described.

In another illustrative embodiment, ambient air may be directed over the hot outer surface of the heat source conduit, for example the vehicle's exhaust pipe, to transfer the heat from the heat source fluid, for example the exhaust gases, to the ambient air or heat carrier fluid. The heat carrier fluid, or heated air, illustratively may be collected in a chamber that encapsulates the required length of the vehicle's exhaust pipe. The heated ambient air chamber will ingress through an inlet opening, which may be equipped with a filter if desired, such that it illustratively flows across the exhaust system or pipe's outer surface. Such flow illustratively may be counter current to the exhaust gas flow. Illustratively, the chamber may be coupled to the exhaust pipe by a clamp on the chamber or it may replace the entire exhaust pipe system with a co-annular heat exchanger wherein the hot exhaust gases from the chassis engine flow through the center section of the device and the ambient air to be heated flows across the surface of the center section that is being heated by the exhaust gases as further described herein. These hot gases then illustratively may be collected and transferred to the respective compartment that requires heating. Illustratively, the system could include temperature monitoring in the compartment that allows the temperature of the compartment to be controlled by a series of shut-off valves and/or by a bypass mode that control heat fluid flow to the compartment based on the temperature of the compartment. The fans or blowers illustratively could be a suction fan on the exit end of the heated compartment or a forced air fan on the entry end of any heated compartment. Hot fluid, for example gases, could be designed to flow through a series of compartments by applying gas flow openings to assure that proper ventilation occurs throughout the compartment and does not short circuit from one compartment through the other. The general arrangement will be to have an entry opening on the upper end of the side wall or horizontal wall and have the exit openings on the opposite walls located to assure that hot air traverses the entire compartment.

It will be appreciated that in any of the illustrative embodiments a series of tubing could run through the compartments as well, with a utility heat fluid flowing through the tubing to transfer heat to the compartment desired to be heated.

Illustratively, a further improvement to any of the disclosed illustrative embodiments would be to insulate the interior of the compartments or even build a double walled utility body system that would have insulating materials injected between the walls. This insulation would further assist in maintain heat in the compartments, limiting heat loss due to heat transfer through the metal walls of the utility body (plastic, fiberglass, ceramic, steel, stainless steel or aluminum utility body materials.)

An illustrative heat transfer system for transferring heat for use in a utility body of a vehicle is disclosed, the heat transfer system comprising: a heat source; a heat source fluid; and a utility heat exchanger system; wherein conduits are configured to connect the heat source, the utility heat exchanger system and the utility body in fluid communication with one another; and wherein the conduits direct the heat source fluid to the utility body.

Another illustrative heat transfer system for transferring heat for use onboard a vehicle is disclosed, the heat transfer system comprising: a heat source; a heat source fluid; a control system; a heat source disposed between and placing in fluid communication the heat source and the control system and configured to direct the heat source fluid therebetween; a utility heat exchanger in fluid communication with the control system, the utility heat exchanger configured to receive therethrough the heat source fluid; a blower in communication with the utility heat exchanger and an enclosed compartment of the vehicle; wherein the compartment defines an entry opening and an exit opening in fluid communication with the blower.

Further disclosed is an illustrative method of transferring heat comprising the steps of: providing a heat source; producing a heat source fluid in the heat source; directing the heat source fluid to a utility heat exchanger; transferring heat from the heat source fluid to a utility heat fluid; and directing the utility heat fluid into a compartment of a vehicle.

These and other features of the present disclosure will become more apparent from the following description of the illustrative embodiments.

### BRIEF DESCRIPTION OF THE DRAWINGS

FIG. 1 is a diagrammatic view of a vehicle showing the vehicle's utility body including an illustrative vehicle environmental control system or heat transfer system in communication with an engine to receive a heat carrier fluid from the engine to transfer heat to a heat exchanger to heat a utility compartment outside of the passenger compartment of the vehicle, for example;

FIG. 2 is a diagrammatic view of a vehicle showing the vehicle including an illustrative vehicle environmental control system or heat transfer system in communication with an engine to receive engine coolant fluid to transfer heat from the engine coolant fluid through the heat transfer system to a heat exchanger to heat a utility compartment outside of the passenger compartment of the vehicle, for example;

FIG. 3 is another view of the illustrative embodiment of FIG. 2;

FIG. 4 is a diagrammatic view of a vehicle showing the vehicle including an illustrative vehicle environmental control system or heat transfer system in communication with an engine to receive exhaust gas discharged from the engine to transfer heat from exhaust gas to the heat transfer system to heat various utility compartments outside the passenger compartment of the vehicle, for example;

FIG. 5 is a diagrammatic view of a vehicle showing the vehicle including an illustrative vehicle environmental control system or heat transfer system in communication with an engine to receive exhaust gas discharged from the engine to transfer heat from exhaust gas to engine coolant fluid flowing from the engine through the heat transfer system to a heater exchanger system to heat various utility compartments outside the passenger compartment of the vehicle, for example;

FIG. 5A is a cross-section taken generally along the line 5A-5A of FIG. 5 is a diagrammatic view of an illustrative heat exchanger for use with the embodiments of FIGS. 4-5; and

FIG. 5B is a cross-section taken generally along the line 5B-5B of FIG. 5 view of another illustrative heat exchanger for use with the embodiments of FIGS. 4-5.

### DESCRIPTION OF THE ILLUSTRATIVE EMBODIMENTS

For the purposes of promoting an understanding of the principles of the invention, reference will now be made to a number of illustrative embodiments illustrated in the drawings and specific language will be used to describe the same.

Illustratively, the invention provides a method and apparatus, including for example a heat transfer system in combination with a heat exchanger system.

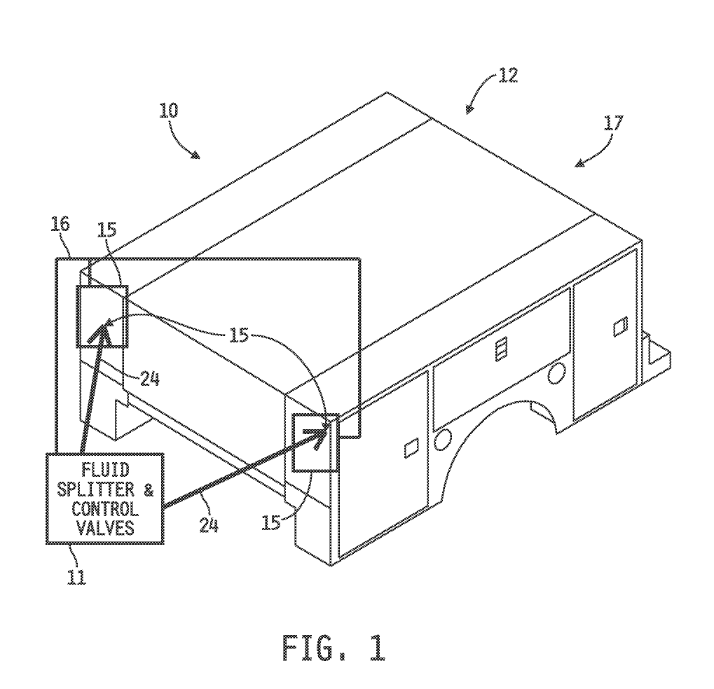

A heat transfer system 10 shown in FIG. 1 is carried onboard a vehicle 12 to communicate with a vehicle engine 14 and a utility heat exchanger system 15 of a vehicle utility body 17 for warming the utility body including for example any compartments and/or items located therein (not shown). Heat transfer system 10 is operable in a heat transfer mode, as shown in the FIGS. and a bypass mode (not shown). It will be appreciated that an illustrative compartment is generally covered or closed such that it comprises a pair of spaced apart and generally parallel sidewalls, sandwiched between a pair of spaced apart and generally parallel top and bottom walls. The walls may define therethrough one or more openings or apertures including without limitation a drawer, a door, an inlet or entry opening and an exit or outlet opening. In addition, the compartments may have any number of walls in any shape or configuration desired.

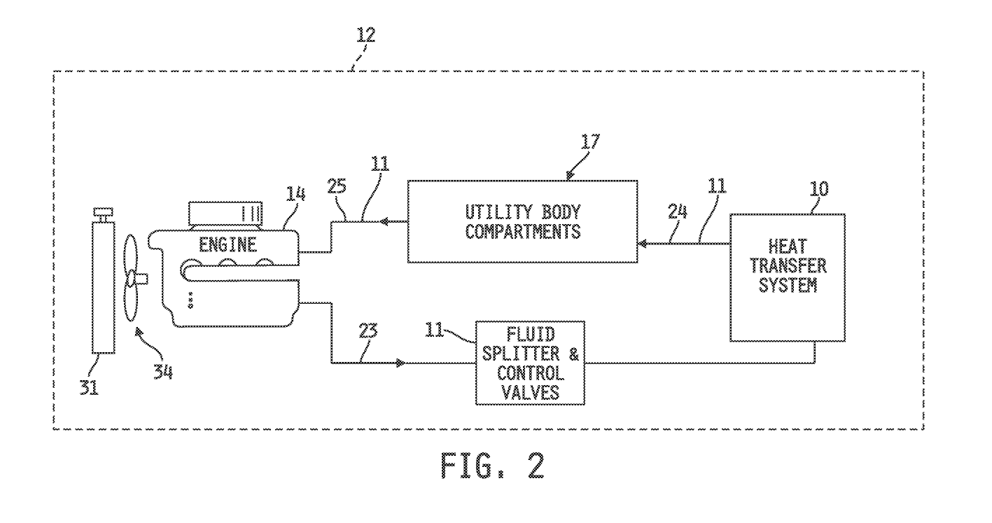

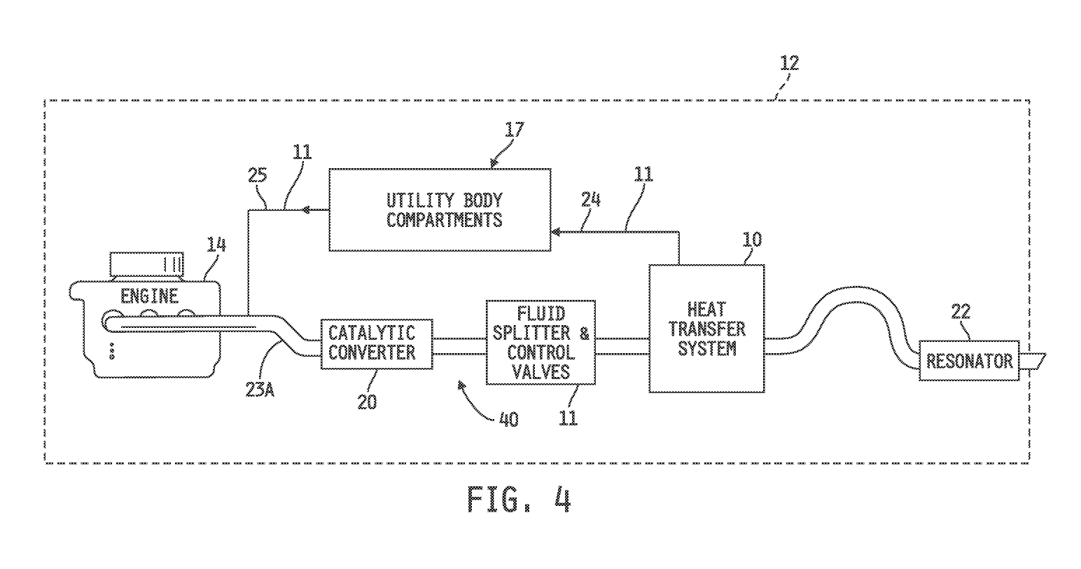

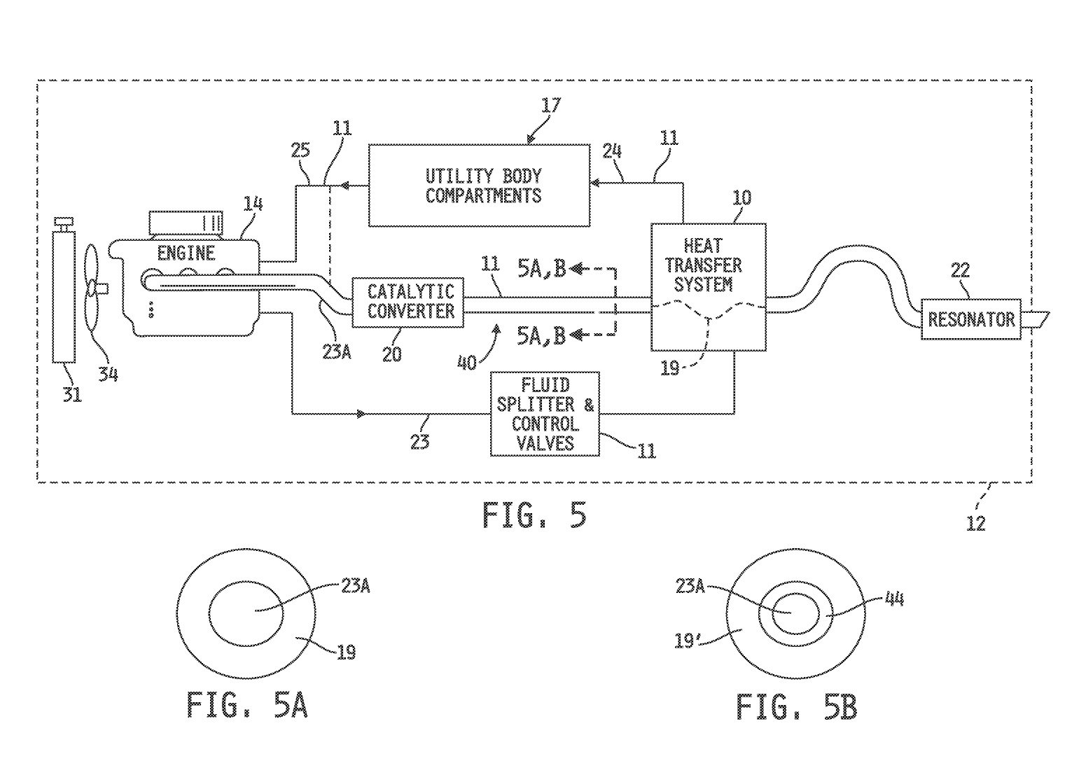

Illustratively, the heat transfer system 10 comprises a control system 11, one or more heat exchanger system(s) 15, associated thermocouple wiring 16, and various conduits or transmission tubes or transfer pipes 23, 24, 25 in fluid communication between the utility body 17 the heat transfer system 10 and the engine 14 as seen in the FIGs. Illustratively, the control system 11 may comprise a fluid splitter and associated control valves and circuitry (not shown). Illustratively, each utility heat exchanger system 15 illustratively comprises a utility heat exchanger and a blower (not shown). The heat source conduit(s) 23 direct the heat source fluid, for example a gas coolant or a liquid coolant, to the heat transfer system 10 and to the control system 11. The heat source fluid may also be or be converted to the heat carrier fluid, for example a gas coolant or a liquid coolant, as will be described. The control system 11 illustratively may direct the heat carrier fluid through the carrier conduit(s) 24 to the one or more heat exchanger(s) 15 as desired. Illustratively, the heat exchanger(s) 15 comprise a series of pipes/coils through which the heat carrier fluid flows. An associated blower fan(s) (not shown) circulate a utility heating fluid, for example air, over the pipes/coils allowing the exchange or recovery of heat by the utility heating fluid from the heat carrier fluid. The now heated and/or dried utility heating fluid or air is forced, blown or directed to one or more utility chambers, compartments or areas 17 as desired. The forced utility heating fluid or air is heated and blown into the specific compartment, heating it to the desired temperature. Illustratively, the system 10 could include temperature monitoring (not shown) in the compartment(s) to allow the temperature of the compartment to be controlled by a series of splitter 11 or shut-off valves 11. The splitter valves and/or the shut-off valves could control the utility heat fluid flow to any desired compartment based on desired temperature for that desired compartment 17. Illustratively, in the alternative, a bypass mode could be used to cut off the flow of either of the heat source fluid or carrier source fluid prior to the fluid splitter to control the temperature of the desired compartment. Illustratively, the blower fans could be a suction fan on the exit end of a utility compartment or space desired to be heated or dried, or it could be a forced air fan on the entry end of a compartment desired to be heated or dried. Illustratively, the utility heat fluid could be designed to flow through a series of one or more compartment(s) by applying fluid flow openings (not shown) to assure that proper ventilation occurs throughout the desired compartment(s) and does not short circuit from one compartment through the other. In such an illustrative case, for example and without limitation, the general arrangement will be to have an entry opening(s) on an upper end of a compartment side wall(s) or horizontal wall(s) and to have an exit opening(s) on the opposite wall(s) located to assure that the utility heat fluid traverses through the entire selected utility compartment(s). Illustratively, all or a portion of the heat carrier fluid could be returned to the engine 14 (FIG. 2), to the exhaust system 40 (FIG. 4), or to a combination of the engine 14 and the exhaust system 40 (FIG. 5) through return conduit(s) 25. The utility heat fluid illustratively could be directed to the exhaust system 40 through return conduit(s) 25, could be recirculated through the compartment heat exchanger(s), could be vented to the ambient environment, or any combination of the foregoing.

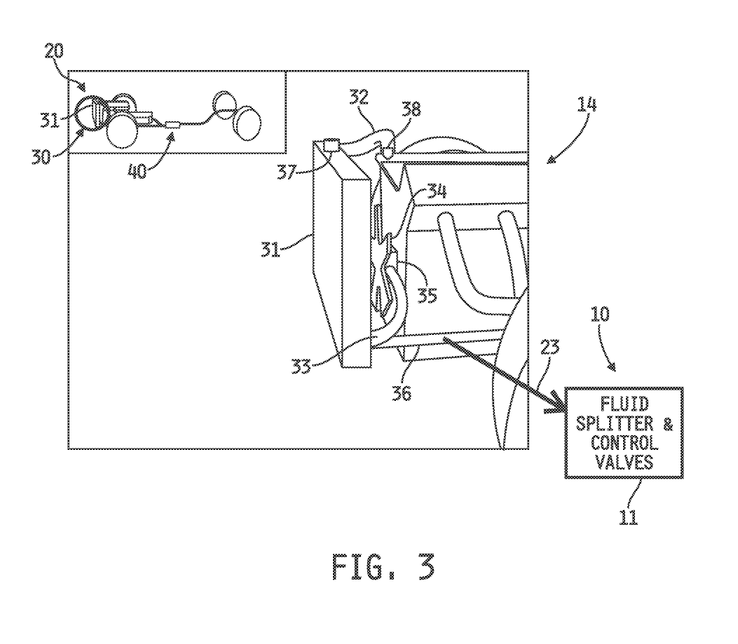

As best seen in FIGS. 2 and 3, one illustrative embodiment uses the same fluid for both the heat source fluid and the heat carrier fluid. For example and without limitation the vehicle radiator fluid, for example water or antifreeze fluid, flows between the engine 14 and the heat transfer system 10 through heat source conduit 23. Without further conditioning, this same radiator fluid now referred to as heat carrier fluid is directed through heat carrier conduit(s) 24 to each utility heat exchanger(s) 15, through to the compartment(s) and then returned to the engine through return conduit(s) 25 as described previously. The conventional engine 14 depicted in FIG. 3 includes the coolant system 30 comprising radiator 31, upper hose 32, lower hose 33, fan 34, pump 35, cooling lines 36, pressure cap 37 and thermostat 38. As shown in FIG. 3, the system 30 is in communication with the heat transfer system 10 including control system 11 via conduit 23.

Turning to FIG. 4, the heat source fluid, illustratively hot exhaust gases, illustratively flow from the engine 14 to the heat transfer system 10 including control system 11 through heat source conduit or exhaust pipes 23A. Illustratively, without further conditioning, this same exhaust gas is directed through heat carrier conduit(s) 24 to each utility heat exchanger(s) (not shown), through to the compartment(s) 17 and then returned to the exhaust pipes 23A through return conduit(s) 25 as described previously.

Referring to FIG. 5, in another illustrative embodiment, heat transfer system 10 transfers heat from exhaust gas discharged from engine 14 to a heat carrier fluid circulating through a carrier heat exchanger 19. Illustratively, the carrier heat exchanger could comprise an outer tube 19, 19′ (FIGS. 5A and 5B) or coil coupled with or covering the exhaust pipe 23A. In the alternative, the heat exchanger 19 illustratively could replace the exhaust pipe 23A altogether. Illustratively, the exhaust gas serves as the heat source fluid flowing through the exhaust pipe 23A to the heat transfer system 10. The heat carrier fluid illustratively is water or antifreeze fluid, which illustratively could flow from the radiator via heat source conduit 23 or from a separate source (not shown), into the carrier heat exchanger 19, 19′. It will be appreciated that the heat carrier fluid illustratively could instead comprise a gas, such as for example ambient air flow as will be described. Prior to entering the heat exchanger 19, 19′ the heat carrier fluid could be considered a second heat source fluid. The water/antifreeze fluid recovers heat from the exhaust gas as the exhaust gas passes through the heat exchanger 19, 19′. The further conditioned or heated water/antifreeze fluid continues through the control system including fluid splitter/control valves 11 to the utility heat exchanger(s)/blower(s) 15 as described above for example. If the water/antifreeze fluid came from the engine, it returns to the engine 14 via the return conduit(s) 25. If the water/antifreeze fluid came from an independent source, then it will be returned to that source for recirculation through the heat exchanger 19, 19′. The exhaust gases continue out the exhaust pipe through the resonator 22 or muffler. It will be appreciated that the independent source of the water/antifreeze fluid could be relatively cooler fluid that cools the exhaust gases, which could then be cooled thereby in the carrier heat exchanger and circulated to cool rather than heat the utility heat fluid in the utility heat exchanger 15. It will be further apparent that any heat recovered from the exhaust gases can further be used to warm up engine 14 to reduce the amount of time needed to reach the activation temperature of the catalyst within catalytic converter 20 to reduce noxious engine exhaust emissions. As noted, the carrier heat exchanger 19, 19′ illustratively could replace the entire exhaust pipe 23A as a single unit or the heat exchanger 19, 19′ could be for example a bolt on device that attaches to the exterior of the existing exhaust pipe 23A.

Referring to FIGS. 5A and 5B, illustrative embodiments of the carrier heat exchanger 19, 19′ are disclosed. Illustratively, as best seen in FIG. 5A, the carrier heat exchanger 19 could comprise a heat exchanger wrapped around or covering at least a portion of the longitudinal length of exhaust pipe 23A, without any intervening space or gap between the overlying heat exchanger 19 and the underlying exhaust pipe 23A. Illustratively, as best seen in FIG. 5B, the carrier heat exchanger 19′ could comprise a heat exchanger wrapped around or covering at least a portion of the longitudinal length of the exhaust pipe 23A with a fluid gap 44, for example and without limitation air, sandwiched between the heat exchanger 19′ and the exhaust pipe 23A. Such an intervening air gap could provide thermal insulation. It will be appreciated that the heat exchanger 19, 19′ illustratively encapsulates or wraps circumferentially entirely around the underlying exhaust pipe 23A. In one illustrative embodiment, the carrier heat exchanger 19, 19′ (FIG. 5A, 5B) has a heat carrier fluid comprising a liquid, for example water or antifreeze fluid. In another illustrative embodiment, the carrier heat exchanger 19, 19′ (FIG. 5A, 5B) has a heat carrier fluid comprising a fluid comprising a gas, for example ambient air flow.

It will be appreciated that in any of the illustrative embodiments a series of tubing could run through the compartments as well, with a utility heat fluid flowing through the tubing to transfer heat to the compartment desired to be heated rather than being directed directly into the compartment as has been described.

The various components of the environmental control system 10 or heat recovery system 10 may be fashioned from any suitable metallic, non-metallic or composite material or combination thereof using any method of manufacture suitable to the material used.

Illustratively, the interior of the utility compartments could be insulated. The utility body, including the utility compartments illustratively could comprise a double walled utility body system that illustratively could have insulating materials injected between the walls. The insulation illustratively would cooperate with the heat exchange system described and disclosed herein to further assist in maintaining the desired temperature or heat and humidity or dryness in the compartments, limiting heat loss due to heat transfer through the walls of the utility body. The utility body walls could be fashioned using any method of manufacture suitable to the material used, which utility body material may be of any suitable metallic, non-metallic or composite material or combination thereof including for example and without limitation plastic, fiberglass, ceramic, steel, stainless steel or aluminum.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. A heat transfer system for transferring heat for use in a utility body of a vehicle, the heat transfer system comprising:
a heat source;
a heat source fluid; and
a utility heat exchanger system;
wherein conduits are configured to connect the heat source, the utility heat exchanger system and the utility body in fluid communication with one another; and
wherein the conduits direct the heat source fluid to the utility body.

2. The heat transfer system of claim 1 further comprising a heat carrier fluid.

3. The heat transfer system of claim 2 wherein the heat carrier fluid and the heat source fluid comprise the same fluid.

4. The heat transfer system of claim 2 wherein the heat carrier fluid and the heat source fluid comprise different fluids.

5. The heat transfer system of claim 2 wherein the heat carrier fluid and the heat source fluid comprise a gas.

6. The heat transfer system of claim 2 wherein the heat carrier fluid and the heat source fluid comprise a liquid.

7. The heat transfer system of claim 2 wherein the heat carrier fluid comprises a gas and the heat source fluid comprise a liquid.

8. The heat transfer system of claim 2 wherein the heat carrier fluid comprises a liquid and the heat source fluid comprise a gas.

9. The heat transfer system of claim 2 wherein the heat source comprises the vehicle engine.

10. The heat transfer system of claim 2 further comprising a carrier heat exchanger system in fluid communication with the heat carrier fluid.

11. The heat transfer system of claim 10 wherein the carrier heat exchanger envelopes at least a portion of a longitudinal length of a conduit.

12. The heat transfer system of claim 11 wherein the heat carrier fluid comprises a gas.

13. The heat transfer system of claim 11 wherein the heat carrier fluid comprises a liquid.

14. The heat transfer system of claim 10 further comprising a control system.

15. The heat transfer system of claim 14 wherein the control system comprises a fluid splitter and a control valve in fluid communication with the heat source and the carrier heat exchanger.

16. The heat transfer system of claim 15 further comprising a blower in communication with the carrier heat exchanger and a compartment of the utility body and further comprising a utility heat fluid in communication with the utility heat exchanger.

17. The heat transfer system of claim 16 wherein the compartment comprises a pair of spaced apart and generally parallel sidewalls, sandwiched between a pair of spaced apart and generally parallel top and bottom walls, and wherein one of the sidewalls defines a fluid entry opening therethrough and in fluid communications with the blower and the utility heat fluid, and the other of the sidewalls defines a fluid exit opening therethrough and in fluid communications with a return conduit.

18. A method of transferring heat comprising the steps of:
providing a heat source;
producing a heat source fluid in the heat source;
directing the heat source fluid to a utility heat exchanger;
transferring heat from the heat source fluid to a utility heat fluid; and
directing the utility heat fluid into a utility compartment of a vehicle.

19. The method of claim 18 further comprising the steps of:
directing the heat source fluid to a carrier heat exchanger;
transferring heat from the heat source fluid to a heat carrier fluid; and
directing the heat carrier fluid to the utility heat exchanger.

20. A heat transfer system for transferring heat for use onboard a vehicle, the heat transfer system comprising:
a heat source;
a heat source fluid;
a control system;
a heat source disposed between and placing in fluid communication the heat source and the control system and configured to direct the heat source fluid therebetween;
a utility heat exchanger in fluid communication with the control system, the utility heat exchanger configured to receive therethrough the heat source fluid;
a blower in communication with the utility heat exchanger and an enclosed utility compartment of the vehicle;
wherein the compartment defines an entry opening and an exit opening in fluid communication with the blower.
